(19) United States
(12) Patent Application Publication
(10) Pub. No.: US 2026/0000056 A1
(43) Pub. Date: Jan. 1, 2026

(54) ILLUMINATED LIVESTOCK BAND AND METHODS

(71) Applicant: Bryce Harding, Porterfield, WI (US)

(72) Inventor: Bryce Harding, Porterfield, WI (US)

(21) Appl. No.: 19/251,643

(22) Filed: Jun. 26, 2025

Related U.S. Application Data
(60) Provisional application No. 63/664,258, filed on Jun. 26, 2024.

(51) Int. Cl. A01K 27/00

(52) U.S. Cl. CPC A01K 27/006; A01K 27/001

(57) ABSTRACT

An illuminated livestock band for application around the limb of livestock to serve as a marker distinguishing the state or condition of the animal. Such states can include, for example, a medicated state wherein the cattle is receiving antibiotics. Reliable identification assures milk from medicated cows does not contaminate milk distributed for human consumption. The illuminated band comprises varied colored lights that can be blinking or have constant illumination. Each color or illumination state can indicate a state or condition of the animal. Program switches are used for the user to operate the lights and/or blinking. The livestock band can utilize components such as a printed circuit board on which a combination of switches, integrated chip, capacitors, battery, resistors, and LEDs are utilized. A portion of the livestock band houses the electronic components and can include locking/release mechanisms for easy removal and application of the band from the animal.

This Non-Provisional Patent application claims priority to Provisional Patent Application No. 63/664,258 filed Jun. 26, 2024, the entire disclosure of which is hereby incorporated by reference and relied upon.

### BACKGROUND OF THE INVENTION

### Field of the Invention

The invention relates generally to markers for livestock, and more particularly to illuminated markers for identification of livestock having specific medical profiles or other conditions.

### Description of Related Art

In farming environments, livestock often needs to be distinguished based on the various health conditions or other factors, such as medicines, they are taking. For example, milking cows are often administered antibiotics and these cows must be separated from others during milking to avoid contaminating large vessels milk intended for human consumption. Failing to separate the medicated cows can cost a farmer tens of thousands of dollars when the contaminated milk has to be disposed of due to the contamination.

What is needed are devices that assist in separating the medicated and non-medicated livestock and reduce the chance for contamination of dairy products.

### SUMMARY OF THE INVENTION

Disclosed herein is an illuminated livestock band for wearing around a livestock limb that better assists the farmer in distinguishing between medicated and non-medicated livestock. This device is particularly applicable to livestock that is milked and wherein the milk is distributed for human consumption. Also disclosed is a method of using an illuminated livestock band to assure milk from medicated livestock is not accidentally mixed with milk from non-medicated livestock. In addition, in some embodiments, the illuminated livestock band is rechargeable which can include a charge stand that eases recharging of the illuminated livestock band. The charge stand can be mounted to various anchors such as a fence post or top of a fence to assure convenient access by a user.

In one form, an illuminated livestock band comprises illuminated livestock band electronics including a printed circuit board (PCB) comprising a variety of electronic components.

In one form, the illuminated livestock band (ILB) comprises one or more lights. The lights can be in the form of LEDs.

In one form, there is a plurality of lights varying in colour such as green, yellow/orange and red or other assigned colours.

In one form, the lights are constantly illuminated, off, or in a blinking or flashing mode.

In one form, a switch, or multiple switches are utilized to operate the lights.

In one form, one click pressure activation of the switch will activate a red light, two clicks activates a orange/yellow light, three clicks activates a green light, and a fourth click switches off all lights.

In one form, the switch is coupled to a pressure actuated button that can be actuated by finger pressure from a user.

In one form, a resistor is electrically coupled to each light to control and ensure uniformity of current flowing into each bulb.

In one form, the PCB comprises amplifiers corresponding to each LED light for imparting a blinking/flash feature.

In one form, the PCB comprises capacitors to limit reverse surge of battery power.

In one form, the PCB comprises a battery input with two terminals to input power from a battery.

In one form, the PCB comprises an integrated chip to direct overall functioning of the circuits based on a predetermined program mapped on the IC chip.

In one form, the PCB is fixed into a unit body with fasteners extending through fastening points of the PCB.

In one form, the unit body is coupled to a limb band used to encircle a limb of an animal and lock in a secured configuration using a band lock.

In one form, the limb band and/or band lock is injection molded using a polymer such as TPU (thermoplastic polyurethane).

In one form, the unit body is injection molded using a polymer such as in PP-EPDM.

In one form, the unit body will house the PCB (containing lights, circuitry, switch) and battery.

In one form, the unit body also houses a provision of RFID (i.e. slot for RFID).

In one form, a removable battery capture cover is utilized to expose a battery for insertion or removal from the battery capture for charging. The battery capture cover can also secure the battery within the unit body.

In one form, a PCB capture for containing the circuitry, LED bulb(s), switches, and other electrical components will be of dimensions approximately 45 mm×45 mm×15 mm.

In one form, three LED bulbs (i.e. each 5 mm in diameter) are used.

In one form, the operating switch is approximately 10 mm in height

In one form, the battery proposed is rechargeable type.

In one form, the battery once fully charged will last for at least 17 days which is the maximum vaccination time zone spread assuming one of the lights remains on for 24 hours a day.

In one form, SMPS assembly is provided separately for recharging the battery.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts an end view of an illuminated livestock band with a limb band in a secured configuration in a band lock;

FIG. 2 depicts a bottom view of the illuminated livestock band of FIG. 1;

FIG. 3 depicts a side view of the illuminated livestock band of FIG. 1;

FIG. 4 depicts a perspective view of the illuminated livestock band of FIG. 1;

FIG. 5 depicts another perspective view of the illuminated livestock band of FIG. 1;

FIG. 6 depicts another perspective view of the illuminated livestock band of FIG. 1 with the limb band in a released configuration from the band lock;

FIG. 7A depicts an end view of an illuminated livestock band with limb band in a secured configuration;

FIG. 7B depicts a perspective view of the illuminated livestock band of FIG. 7A;

FIG. 8 depicts a top view of the illuminated livestock band of FIG. 7A;

FIG. 9 depicts a side view of the illuminated livestock band of FIG. 7A;

FIG. 10 depicts an end view of an illuminated livestock band with limb band in a secured configuration;

FIG. 11 depicts a perspective view of the illuminated livestock band of FIG. 10;

FIG. 12 depicts a side view of the illuminated livestock band of FIG. 10;

FIG. 13 depicts another side view of the illuminated livestock band of FIG. 10;

FIG. 14 depicts a perspective view of an illuminated livestock band with band in a secured configuration in a band lock;

FIG. 15 depicts an exploded perspective view of the illuminated livestock band of FIG. 14;

FIG. 16 depicts an end view of the illuminated livestock band of FIG. 14;

FIG. 17 depicts a perspective view of the illuminated livestock band of FIG. 14;

FIG. 18 depicts a front perspective view of an illuminated livestock band charger;

FIG. 19 depicts a rear perspective view of the illuminated livestock band charger of FIG. 18;

FIG. 20 depicts a perspective view of illuminated livestock bands in a charge mode on the illuminated livestock band charger of FIG. 18;

FIG. 21 is a flow diagram depicting steps in a method of charging illuminated livestock bands on an illuminated livestock band charger;

FIG. 22 depicts a top perspective view of an illuminated livestock band without electronic components;

FIG. 23 depicts a bottom perspective view of the illuminated livestock band of FIG. 22;

FIG. 24 depicts an opposing top perspective view of the illuminated livestock band of FIG. 22;

FIG. 25 depicts a cross-sectional view of the illuminated livestock band of FIG. 22 providing a view to the internal cavities;

FIG. 26 depicts a top view of illuminated livestock band electronics including a printed circuit board with electrical components utilized in an illuminated livestock band;

FIG. 27 is a side view of a cow with an illuminated livestock band in a secured configuration around the lower limb of a cow.

### DETAILED DESCRIPTION OF SELECTED EMBODIMENTS OF THE INVENTION

Select embodiments of the invention will now be described with reference to the Figures. Like numerals indicate like or corresponding elements throughout the several views and wherein various embodiments are separated by letters (i.e. 100, 100B, 100C). The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes, or which is essential to practicing the invention described herein.

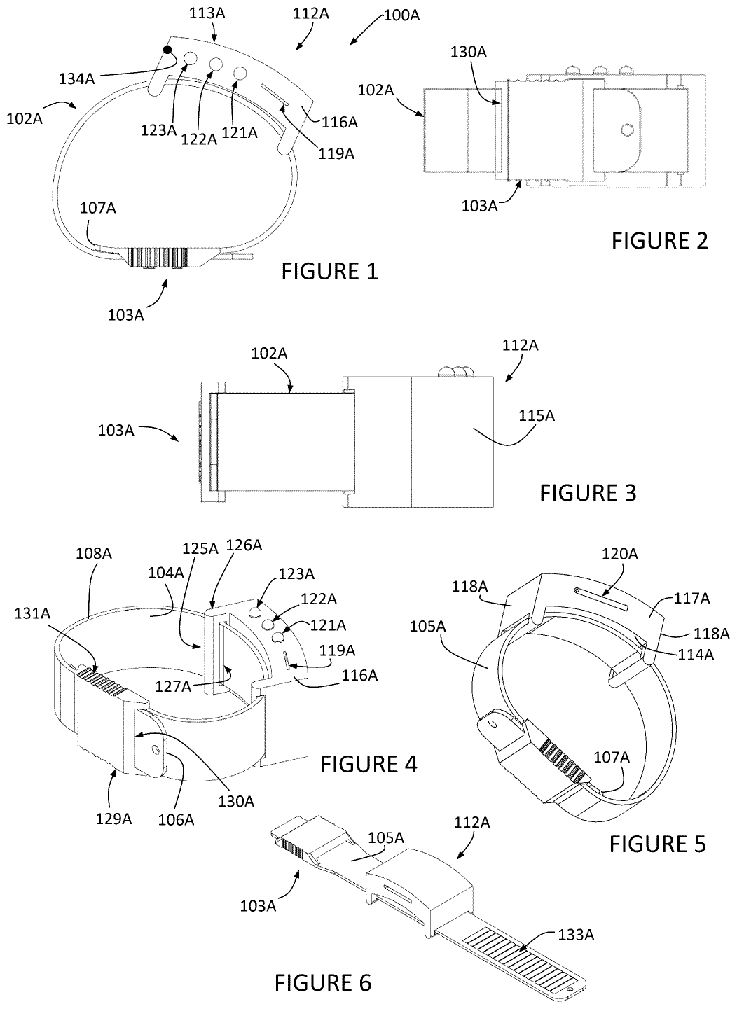

FIGS. 1-5 depict an embodiment of an illuminated livestock band 100A operable for securing around a limb of a selected livestock. The colored and/or flashing lights on the band serve to alert farmhands of special handling of specific livestock. For example, a lit or flashing band can be an indicator to a farmhand that the banded livestock is currently taking antibiotics. Therefore, the milk or perhaps meat from the livestock should not be consumed and must be separated from milk or meat ready for human consumption.

As depicted in FIG. 1, the illuminated livestock band 100A comprises a flexible limb band 102A capable of encircling a limb of the animal. The flexible limb band is typically manufactured from a polymer although other materials can be used. The limb band comprises an inner band face 104A for facing the limb and an opposing outer band face 105A that faces outward. The end of the limb band terminates in a first end band face 106A at one end, and a second end band face 107A at an opposing end. The limb band is further defined by a pair of opposed side band faces extending between the inner band face and outer band face.

An illumination unit 112A is secured directly to limb band 102A using fasteners, adhesives, passages in the illumination unit, or other known measures known in the art. The illumination unit can assume a variety of profiles such as a curved rectangle as depicted here. In one embodiment, unit body 113A has a curved generally rectangular unit body 113A that comprises a band capture 125A comprising a pair of capture walls 126A extending from the unit body's inner unit face 114A. A capture aperture 127A extends through the capture walls for the passage of limb band 102A therethrough as depicted in FIG. 4 thereby securing the illumination unit to the limb band. Unit body 113A comprises an outer unit face 115A that faces away from the animal's limb and is opposed to the inner unit face. A first unit side face 116A and opposing second unit side face 117A define the sides of the unit body 113A. Opposing unit end faces 118A provide further definition to the ends of the unit body. The illumination unit can also comprise a RFID slot with RFID chip 119A inset in first unit side face 116A which is opposite second unit side face 117A. A battery capture with battery 120A is inset within second unit side face 117A. One or more lights can be mounted to or extend through various outward faces as depicted in FIG. 4. Here, a first light 121A, a second light 122A, and a third light 123A are mounted within first unit side face 116A. In this embodiment, the lights are LED type, however, other types of lights known in the art can be used. In some embodiments, a light switch 134A (activation and deactivation switch) can be included to turn one or more lights on or off. The lights can be of the same color or vary in color with each color having a defined meaning to the user. For example, one light color can indicate ‘antibiotics in use’, whereas another light color can indicate other medications. In some embodiments, the lights can be made to flash.

In this embodiment, a band lock 103A is used to secure and release the illuminated livestock band from the animal's limb. Band lock 103A comprises a generally rectangular band lock body 129A. Extending through the band lock body is a band lock tunnel 130 in which the opposing ends of the band are secured for clamping. Outer surfaces of the band lock body 129A can comprise grip bars 131A to assist the user in application of the device around an animal's limb. Lock bars 133A can be included on the inner band face 104A and/or outer band face 105A for use in the locking mechanism of the band when locking about a limb of a livestock.

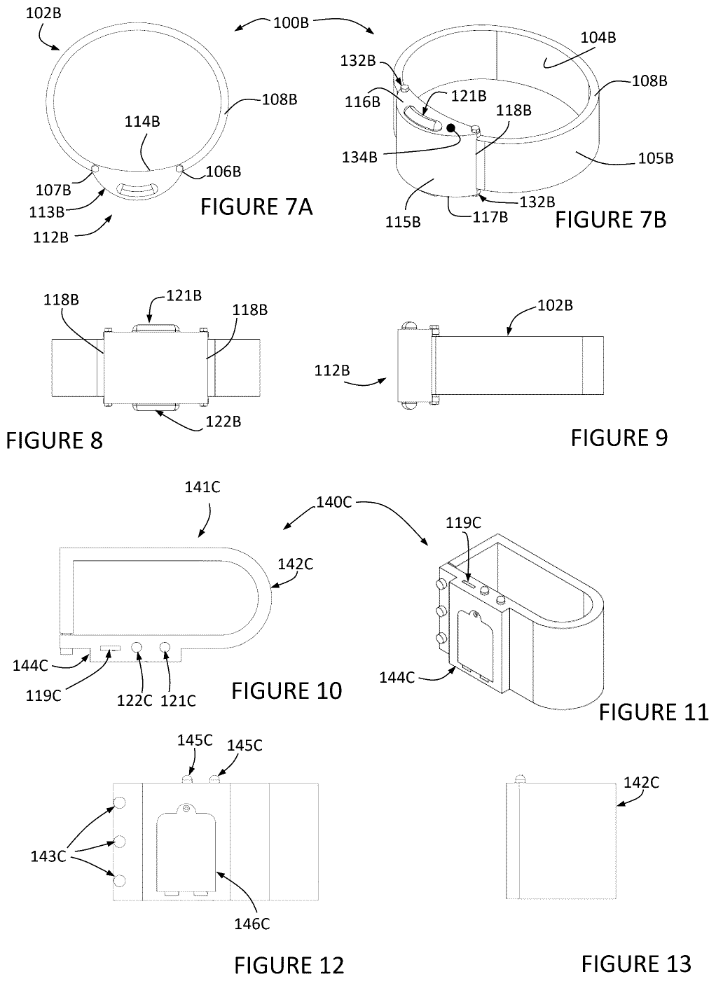

Another embodiment of an illuminated livestock band 100B is depicted in FIG. 7A-9. In this embodiment, the limb band 102B is secured to the illumination unit 112B via a strap fastener 132B. Here, the strap fastener is in the form of a threaded screw that screws through first end ban face 106B and second end band face 107B into unit body 113B. In this embodiment, first light 121B is opposed to second light 122B on illumination unit 112B.

In some cases, a RFID chip 119A is included in the illumination unit as depicted in FIG. 1. In this case, a RFID reader 140C is positioned near machinery used to milk the animal. When used on a cow for example, and the cow walks in proximity to the milking equipment, radio frequencies are generated and received by the RFID reader. Consequently, lights on the reader and on the illuminated livestock band illuminate, thereby alerting the workers about the associated cow and thus causing them to avoid contaminating good milk. In this embodiment, RFID reader 140C is configured to mount to or clamp around a post or a hose used for milking. In this case, the reader comprises a reader clamp 141C having a U-shaped clamp body 142C that is fastened together at one end using one or more fasteners 143C. RFID reader 140C comprises a reader body 144C secured to the side of reader clamp 141C. Reader lights 145C signal operation of the device. A battery is enclosed behind a reader battery cover 146C and is used to power the device.

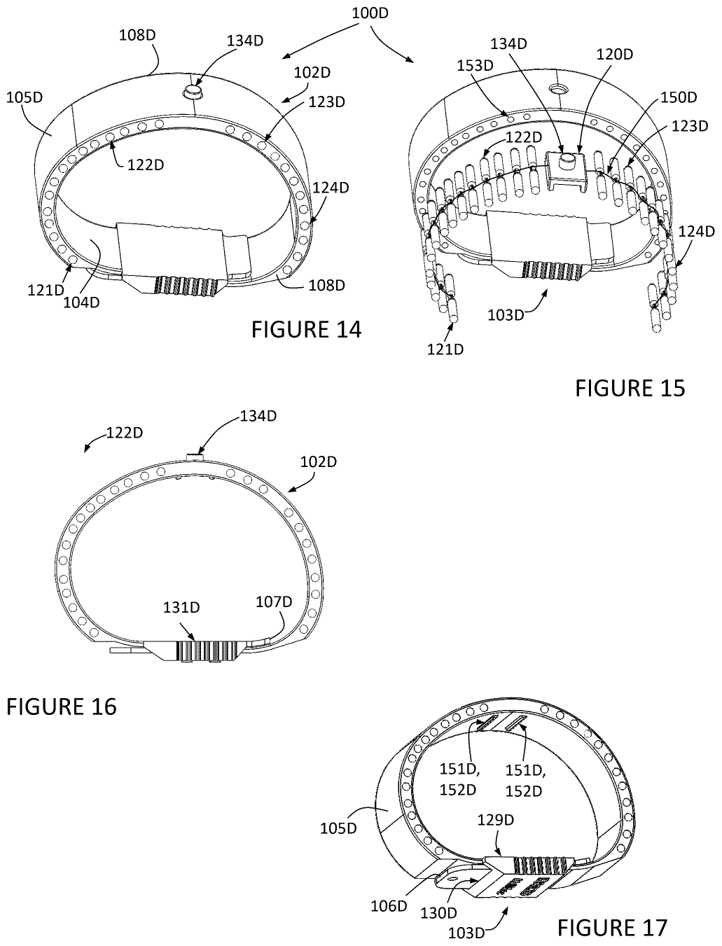

FIGS. 14-17 depict an embodiment of an illuminated livestock band 100D wherein a plurality of lights are integrated into the limb band 102D. For example, a portion of the lights (i.e. first light 121D, second light 122D, third light 123D, fourth light 124D . . . etc.) in this embodiment, extend through one or more of the opposed side band faces 108D. In alternative embodiments, the lights can protrude from other surfaces such as outer band face 105D. As noted in the FIG. 15 exploded view, LED lights are used and contained within light sockets 153D formed within the limb band 102B. The ends of the lights protrude from the limb band 102D to be visible to those nearby. The lights can be constant or blink to have extended life or to serve as indicators for assigned meaning. The lights and the bands can have variations in color and surface design to indicate various issues associated with the livestock (i.e. a particular type of medication or medical condition). The individual lights share power supplied by battery 120D and are electrically coupled via light circuitry 150D extending between them. A light switch 134D interrupts this circuitry to turn the lights on and off in this case by depressing the switch or for example, by activating a slider on the switch. In this embodiment, the limb band 102D is formed through a molding process wherein a polymer such as silicone is injected into a mold to form the band. The lighting circuitry 150D, lights, light switch 134D, and battery 120D are integrated in the mold during the mold process. A plurality of light sockets 153D are thus formed in the band for housing the lights.

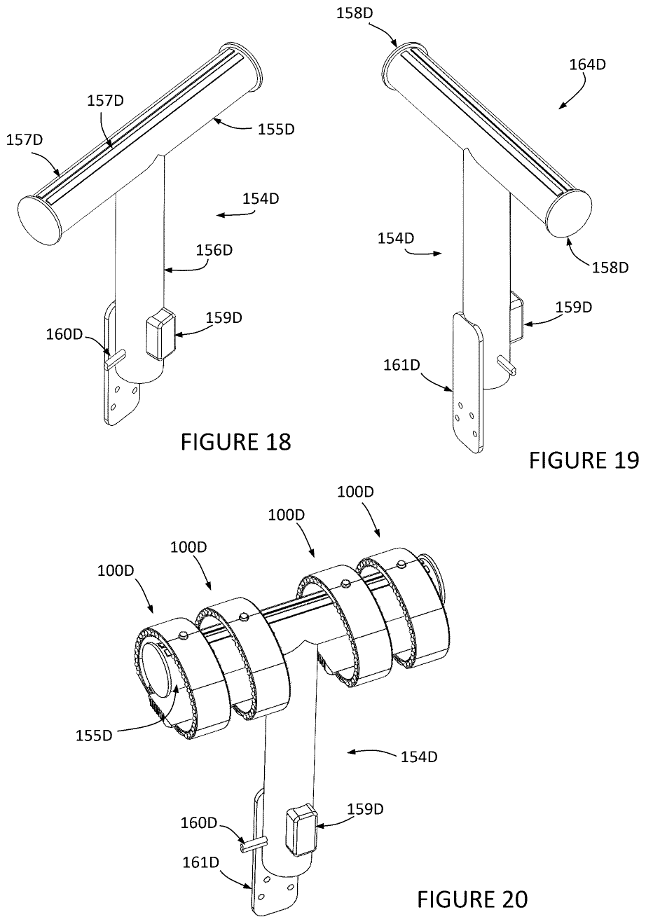

In some embodiments, extending through the inner band face 104D is a pair of receiving charge terminals 151D with receiving faces 152D thereon, for receiving power from an illuminated livestock band charger 164D. This charger can be in a desktop form, outlet mounted form, or other forms such as the one depicted in FIGS. 18-20 that is configured for mounting to a fence or wall. Here, the illuminated livestock band charger 164D comprises a charge stand 154D comprising a charge arm 155D that is substantially horizontal. A support arm 156D descends downward from the charge arm for fixation to an anchoring site such as ground, a wall, or fence. A mount plate 161D with fastening holes extending through can be used to ease mounting the charge stand to a vertical surface such as a fence post, or to other surfaces such as horizontal surfaces if the mount plate is orientated properly. Extending across the top surface of charge arm 155D, is a pair of spaced supply charge terminals 157D that face upward and receive electrical power from input power 160D. A transformer 159D can be utilized as needed to step-up or step-down voltage supplied to the supply charge terminals. End blocks 158D, depicted here in the form of a disc, can be used to prevent one of the illuminated livestock bands from unintentionally falling off the charge arm. To remove the band, the band is lifted over the end block, the band lock is released, place over the limb, then resecured so as to remain on the limb of the livestock. In preferred embodiments, the illuminated livestock band is waterproof.

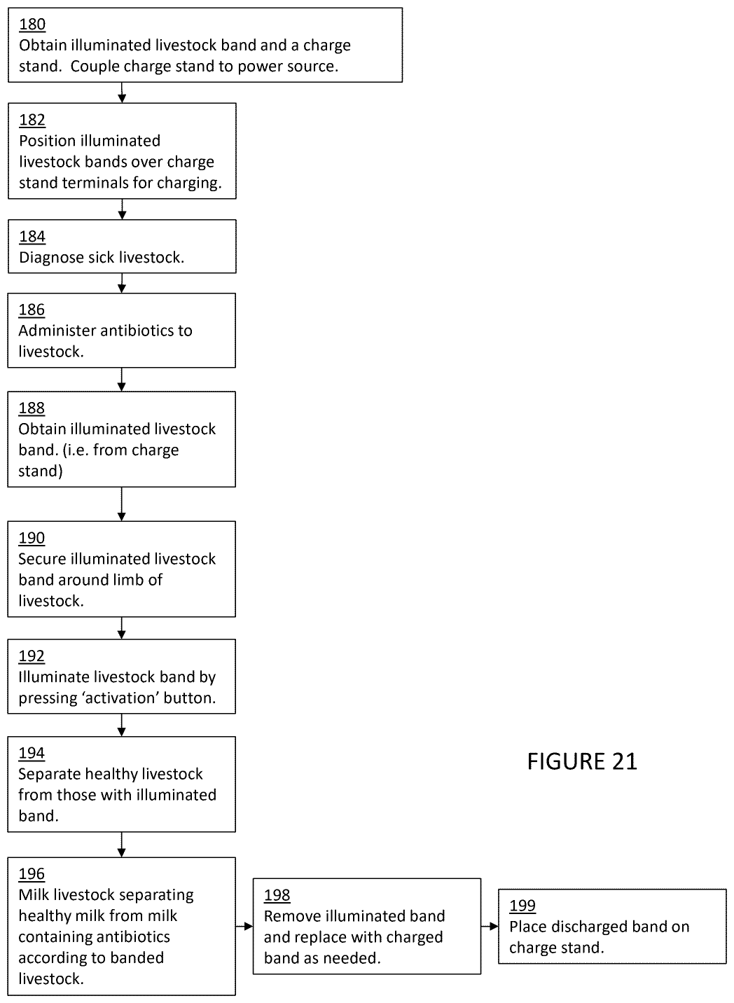

A method for using an illuminated livestock band to prevent contamination of uncontaminated milk with contaminated milk comprises the following steps and is depicted in FIG. 21. Obtain an illuminated livestock band and a charge stand for the bands, and couple the charge stand to a power source (180). Slide the illuminated livestock band over the charge arm of the charge stand such that the respective receiving charge terminals and supply charge terminals are in contact for charging (182). Diagnose sick livestock (184) and administer medicine such as antibiotics to the livestock (186). Obtain the illuminated livestock band by removing it from the charge arm over the end block (188). Secure the illuminated livestock band around a limb of the livestock in a position easily visible to an individual who would milk the livestock (190). Illuminate the livestock band by pressing the activation-deactivation (light switch) button (192). Separate the healthy livestock (i.e. non-medicated) from those having an illuminated livestock band (194). Milk the livestock separating healthy milk from milk containing antibiotics according to the banded livestock (196). Remove the illuminated livestock band and replace it with a charged band as needed (198). Place discharged bands on the charge stand for recharging (199).

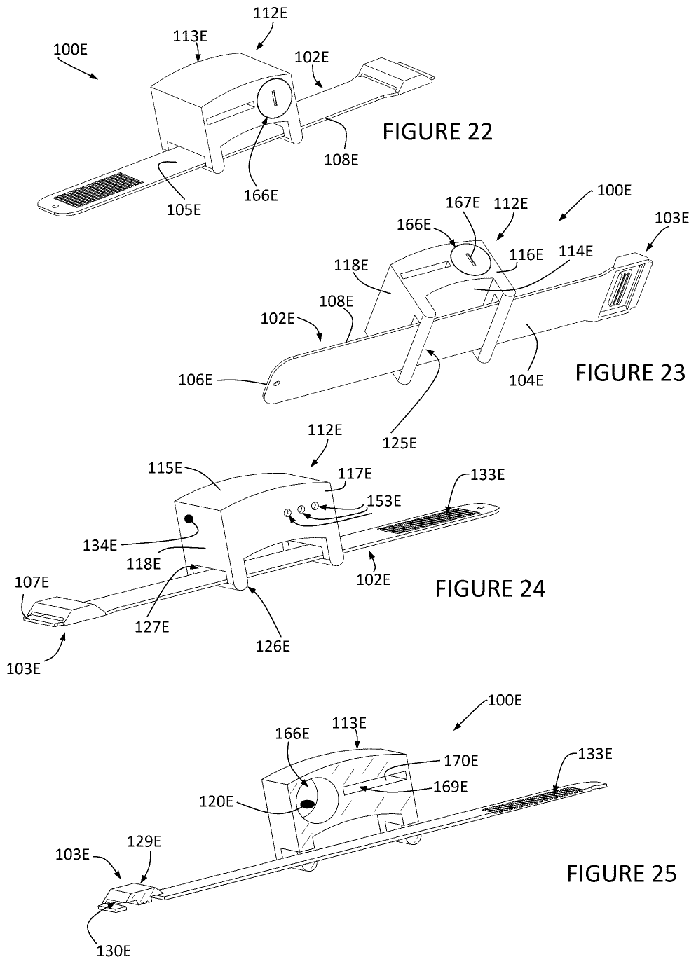

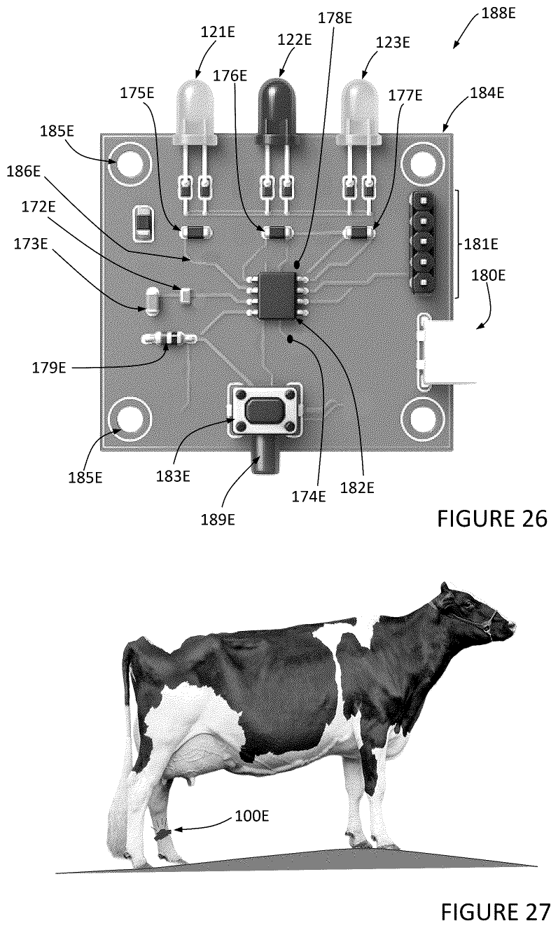

Depicted in FIGS. 22-25 is yet another embodiment of an illuminated livestock band 100E with substantially all the electronics removed. The electronics are depicted in FIG. 26. In this embodiment, ILB electronics 188E comprises a printed circuit board (PCB) 184E on which many of the electronic components are mounted and soldered. The PCB can include one or more mount holes 185E for housing a fastener to secure the PCB to unit body 113E. The illuminated livestock band (ILB) comprises one or more lights which can be in the form of LEDs. Here, first light 121E is green, second light 122E is yellow/orange, and third light 123E is red. The lights can be utilized in any combination of constantly illuminated, off, or in a blinking or flashing mode.

A control switch 183E, or multiple switches are utilized to operate the lights. In this embodiment, one click pressure activation of control switch 183E will activate a red light, two clicks activates an orange/yellow light, three clicks activates a green light, and a fourth click switches off all lights. One skilled in the art would recognize however, that other sequences can be used to activate the various lights. The control switch in some embodiments is coupled to a pressure actuated button 189E that can be actuated by finger pressure from a user. In one embodiment for example, an illuminated red light can indicate the livestock is currently receiving medication that can contaminate milk for human consumption. Milk from this animal should be quarantined. An illuminated yellow light indicates the livestock has given birth recently and their milk should be saved to feeding the offspring. Green can be assigned another function such as indicating the livestock is battling a sickness or disease. Flashing of lights can have other meanings.

In this embodiment, a resistor is electrically coupled to each light (first resistor 172E, second resistor 173E, third resistor 174E), to control and ensure uniformity of current flowing into each bulb/LED. ILB electronics 188E can comprise amplifiers (i.e. first amplifier 175E, second amplifier 176E, third amplifier 177E) corresponding to each LED light for imparting the blinking/flash feature. ILB electronics can also comprise capacitors (i.e. first capacitor 178E, second capacitor 179E) to limit reverse surge of battery power. A battery input 180E with two terminals is utilized to input power from a battery. ILB electronics can further comprise an integrated chip (IC chip) 182E to direct overall functioning of the circuits based on a predetermined program mapped on the IC chip. Program switches 181E are utilized to program the circuit such as to switch function to activate selected lights and as well as activating blinking/flash programming. Trace circuitry 186E on the PCB is utilized for electrical connection between electrical components.

The unit body 113E (FIG. 22) is coupled to a limb band 102E which is used in a released configuration to encircle a limb of an animal and lock in a secured configuration using a band lock 103E. The limb band and/or band lock can be injection molded using a polymer such as TPU (thermoplastic polyurethane). Unit body 113E can be injection molded using a polymer such as in PP-EPDM. In this embodiment, unit body 113E houses ILB electronics 188E containing lights, circuitry, switch and battery to form illumination unit 112E. For example, the battery/battery capture 120E defined by a battery capture wall 168E is noted in FIG. 25. A removable battery capture cover 166E is utilized to secure the battery in the battery capture and is removed when removal of the battery is necessary for charging or changing. A battery cover drive 167E depicted here in the form a slot is used to interface with a removal tool such as a screwdriver. PCB capture walls 170E defines a PCB capture 169E configured in size and shape for housing the PCB with its electronics. As depicted elsewhere, the unit body can also house a provision of RFID (i.e. slot for RFID).

In one embodiment, the PCB housing for containing the circuitry, LED bulb(s), switches, and other electrical components will be of dimensions approximately 45 mm×45 mm×15 mm (approx . . . 1.77 in×1.77 in×0.59 in). In addition, three LED bulbs (i.e. each 5 mm in diameter) are used. Also, the operating switch is approximately 10 mm in height. A battery utilized to power the device is preferred to be rechargeable, however other types can be used.

It is preferred that a battery is utilized that once fully charged will last for at least 17 days with lights remaining on for 24 hours a day. This is sufficient to cover the maximum vaccination time zone spread.

In some embodiments, SMPS assembly is provided separately for recharging the battery.

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A method of using an illuminated livestock band substantially as described and illustrated.

2. An illuminated livestock band substantially as described and illustrated.
